(19) United States
(12) Patent Application Publication
(10) Pub. No.: US 2016/0094913 A1
(43) Pub. Date: Mar. 31, 2016

(54) AUDIO TRANSMISSION SYSTEM

(71) Applicants: HONG FU JIN PRECISION INDUSTRY (WUHAN) CO., LTD., Wuhan (CN); HON HAI PRECISION INDUSTRY CO., LTD., New Taipei (TW)

(72) Inventors: DAO-WEI LI, Wuhan (CN); CHUN-SHENG CHEN, New Taipei (TW)

(21) Appl. No.: 14/530,178

(22) Filed: Oct. 31, 2014

(30) Foreign Application Priority Data
Sep. 30, 2014 (CN) 201410517551.5

(51) Int. Cl. H04R 3/00

(52) U.S. Cl. CPC H04R 3/00; H04R 2420/01

(57) ABSTRACT

An audio transmission system includes a plug, a control circuit coupled to the plug, an output interface coupled to the control circuit, and an input interface coupled to the control circuit. The plug is configured to couple to an audio interface of an electronic device. The audio interface is configured to input and output audio signals. The control circuit is configured to control the output audio signals and the input audio signals. The audio signals from the audio interface are output externally via the output interface. External audio signals are input to the audio interface via the input interface.

### CROSS-REFERENCE TO RELATED APPLICATIONS

This application claims priority to Chinese Patent Application No. 201410517551.5 Sep. 30, 2014, the contents of which are incorporated by reference herein.

### FIELD

The subject matter herein generally relates to audio transmission system.

### BACKGROUND

An audio transmission system may be used to input and output audio.

### BRIEF DESCRIPTION OF THE DRAWINGS

Implementations of the present technology will now be described, by way of example only, with reference to the attached figures.

FIG. 1 is a block diagram of one embodiment of an audio transmission system.

FIG. 2 is a circuit diagram one embodiment of the audio transmission system of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series, and the like.

The present disclosure is described in relation to audio transmission system to input and output audio.

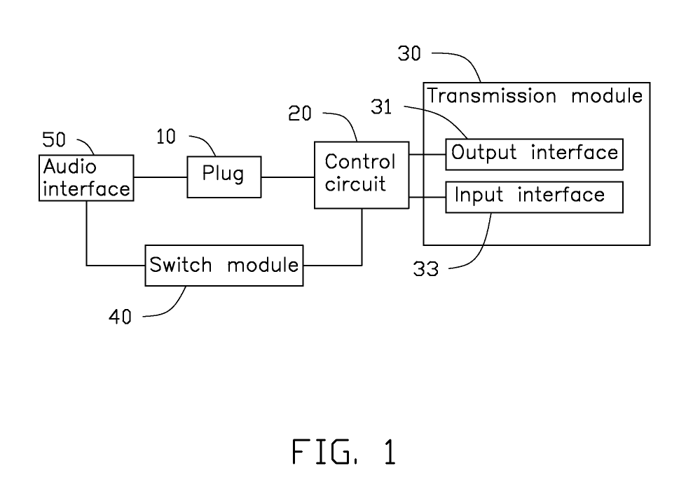

FIG. 1 illustrates an embodiment of an audio transmission system. The audio transmission system comprises a plug 10, a control circuit 20 coupled to the plug 10, a transmission module 30, and a switch module 40. The plug 10 is configured to couple to an audio interface 50 of an electronic device. The audio interface 50 is configured to input audio signals to the electronic device and output audio signals. The transmission module 30 comprises an output interface 31 and an input interface 33 coupled to the control circuit 20. In at least one embodiment, the plug 10 can be an N-earphone plug or an i-earphone plug, the electronic device can be a smart phone, a MP3 player, or a panel computer. In at least one embodiment, the audio interface 50 can be a connector matching the N-earphone plug or be a connector matching the i-earphone plug. In at least one embodiment, each the output interface 31 and the input interface 33 is an audio connector, the output interface 31 is configured to couple to an output device such as an earphone or a speaker, and the input interface 33 is configured to couple to a microphone.

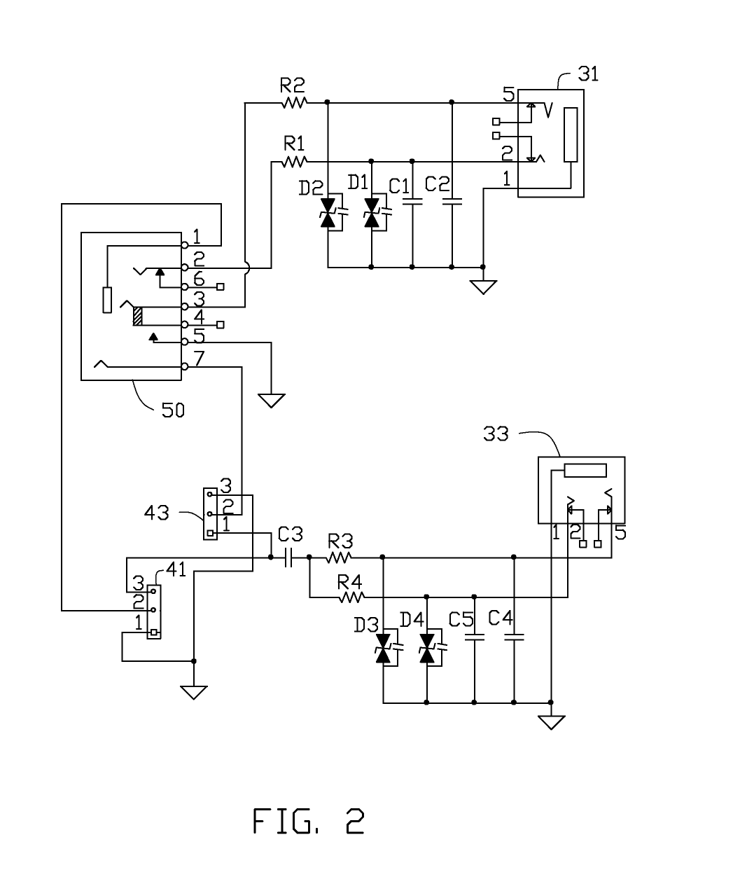

FIG. 2 illustrates that the switch module 40 comprises a first switch 41 and a second switch 43. Both the first switch 41 and the second switch 43 are comprised of a first connecting end 1, a switching end 2, and a second connecting end 3.

The audio interface 50 comprises a first switching pin 1, a first output pin 2, a second output pin 3, and an input pin 7. In at least one embodiment, the first output pin 2 of the audio interface 50 is configured to output left (L) channel audio and the second output pin 3 of the audio interface 50 is configured to output right (R) channel audio.

The control circuit comprises a plurality of resistors, a plurality of capacitors, and a plurality of diodes.

The first output pin 2 of the audio interface 50 is coupled to a first receiving end 2 of the output interface 31 via a first resistor R1. The second output pin 3 of the audio interface 50 is coupled to a second receiving end 5 of the output interface 31 via a second resistor R2. The first receiving end 2 of the output interface 31 is grounded via a first diode D1. The first receiving end 2 of the output interface 31 is grounded via a first capacitor C1. The second receiving end 5 of the output interface 31 is grounded via a second diode D2. The second receiving end 5 of the output interface 31 is grounded via a second capacitor C2.

The switching pin 1 of the audio interface 50 is coupled to a switching end 2 of the first switch 41. The first connecting end 1 of the first switch 41 is grounded. The second connecting end 3 of the first switch 41 is coupled to the first connecting end 1 of the second switch 43. The first connecting end 1 of the first switch 41 is coupled to the second connecting end 3 of the second switch 43. The input pin 7 of the audio interface 50 is coupled to the switching end 2 of the second switch 43. The second connecting end 3 of the first switch 41 is coupled to one end of a third resistor R3 via a third capacitor C3. The other end of the third resistor R3 is coupled to a second receiving end 5 of the input interface 33. The second receiving end 5 of the output interface 31 is grounded via a third diode D3. The second receiving end 5 of the input interface 33 is ground via a fourth capacitor C4. The second connecting end 3 of the first switch 41 is coupled to one end of a fourth resistor R4 via the third capacitor C3. The other end of the fourth resistor R4 is coupled to a first receiving end 2 of the input interface 33. The first receiving end 2 of the input interface 33 is grounded via a fourth diode D4. The first receiving end 2 of the input interface 33 is grounded via a fifth capacitor C5.

When in use, the first switch 41 and the second switch 43 are in a first position. The first connecting end 1 and the switching end 2 of the first switch 41 are coupled to each other. The first connecting end 1 and the switching end 2 of the second switch 43 are coupled to each other. The audio interface 50 matches the N-earphone plug. The first switch 41 and the second switch 43 is located in a second position different from the first position. The second connecting end 3 and the switching end 2 of the first switch 41 are coupled to each other. The second connecting end 3 and the switching end 2 of the second switch 43 are coupled to each other. The audio interface 50 matches the i-earphone plug. The plug 10 is inserted into the audio interface 50. An earphone or a speaker can be inserted into the output interface 31, a microphone can be inserted into the input interface 33.

In the audio transmission system, the first switch 41 and the second switch 43 can be located in the second position or the first position according to the style of the earphone. The electronic device can couple to an earphone or a speaker via the output interface 31. The electronic device can also couple to a microphone via the input interface 33.

It is to be understood that even though numerous characteristics and advantages have been set forth in the foregoing description of embodiments, together with details of the structures and functions of the embodiments, the disclosure is illustrative only and changes may be made in detail, including in the matters of shape, size, and arrangement of parts within the principles of the disclosure to the full extent indicated by the broad general meaning of the terms in which the appended claims are expressed.

What is claimed is:

1. An audio transmission system comprising:
a plug couplable to an audio interface of an electronic device,
a control circuit coupled to the plug,
an output interface coupled to the control circuit, and
an input interface coupled to the control circuit,
wherein the audio interface is configured to input audio signals and output audio signals, the control circuit is configured to control the output audio signals and control the input audio signals, and the audio interface is output externally via the output interface, and external audio signals is input to the audio interface via the input interface.

2. The audio transmission system of claim 1, wherein the audio interface comprises a first output pin and a second output pin configured to output audio signals, the audio interface further comprises an input pin configured to input audio signals, the audio signals from the audio interface are output to the output interface via the first output pin and the second output pin, and the audio signals from the input interface are input to the interface via the input pin.

3. The audio transmission system of claim 2, wherein the control circuit comprises a first resistor and a second resistor, the first output pin of the audio interface is coupled to a first receiving end of the output interface via the first resistor, and second first output pin of the audio interface is coupled to a second receiving end of the output interface via the second resistor.

4. The audio transmission system of claim 3, wherein the control circuit further comprises a first diode and a second diode, the first receiving end of the output interface is grounded via the first diode, and the second receiving end of the output interface is grounded via the second diode.

5. The audio transmission system of claim 1, wherein the audio interface is configured to couple to a microphone.

6. The audio transmission system of claim 1, further comprises a switch module, wherein the audio interface matches an N-earphone plug when the switch module is in a first position.

7. The audio transmission system of claim 6, wherein the audio interface matches an i-earphone plug when the switch module is in a second position different position.

8. The audio transmission system of claim 7, wherein the switch module comprises a first switch and a second switch, each the first switch and the second switch comprises a first connecting end, a second connecting end, and a switching end, a first switching pin of the audio interface is coupled to the switching end of the first switch, the first connecting end of the first switch is coupled to the first connecting end of the second switch, the first switching pin of the audio interface is coupled to the switching end of the first switch, and the second switching pin of the audio interface is coupled to the switching end of the second switch.

9. The audio transmission system of claim 8, wherein when the switch module is in the first position, the first connecting end of the first switch and the switching end of the first switch are coupled to each other, the first connecting end of the second switch and the switching end of the second switch are coupled to each other.

10. The audio transmission system of claim 8, wherein when the switch module is in the second position, the second connecting end of the first switch and the switching end of the first switch are coupled to each other, the second connecting end of the second switch and the switching end of the second switch are coupled to each other.

11. An audio transmission system comprising:
a plug couplable to an audio interface of an electronic device,
an output interface configured to output audio, and
an input interface configured to input audio,
wherein the audio interface is configured to input audio signals and output audio signals, the audio signals from the audio interface is output externally via the output interface, and external audio signals are input to the audio interface via the input interface.

12. The audio transmission system of claim 11, wherein the audio interface comprises a first output pin and a second output pin configured to output audio signals, the audio interface further comprises an input pin configured to input audio signals, the audio form the audio interface is output to the output interface via the first output pin and the second output pin, and the audio signals from the input interface are input to the interface via the input pin.

13. The audio transmission system of claim 12, further comprises a control circuit coupled to the plug, the control circuit is configured to control to output the audio and input the audio, the control circuit comprises a first resistor and a second resistor, the first output pin of the audio interface is coupled to a first receiving end of the output interface via the first resistor, and second first output pin of the audio interface is coupled to a second receiving end of the output interface via the second resistor.

14. The audio transmission system of claim 13, wherein the control circuit further comprises a first diode and a second diode, the first receiving end of the output interface is grounded via the first diode, and the second receiving end of the output interface is grounded via the second diode.

15. The audio transmission system of claim 11, wherein the audio interface is configured to couple to a microphone.

16. The audio transmission system of claim 11, further comprises a switch module, wherein the audio interface matches an N-earphone plug when the switch module is in a first position.

17. The audio transmission system of claim 16, wherein the audio interface matches an i-earphone plug when the switch module is in a second position different position.

18. The audio transmission system of claim 17, wherein the switch module comprises a first switch and a second switch, each the first switch and the second switch comprises a first connecting end, a second connecting end, and a switching end, a first switching pin of the audio interface is coupled to the switching end of the first switch, the first connecting end of the first switch is coupled to the first connecting end of the second switch, the first switching pin of the audio interface is coupled to the switching end of the first switch, and the second switching pin of the audio interface is coupled to the switching end of the second switch.

19. The audio transmission system of claim 18, wherein when the switch module is in the first position, the first connecting end of the first switch and the switching end of the first switch are coupled to each other, the first connecting end of the second switch and the switching end of the second switch are coupled to each other.

20. The audio transmission system of claim 18, wherein when the switch module is in the second position, the second connecting end of the first switch and the switching end of the first switch are coupled to each other, the second connecting end of the second switch and the switching end of the second switch are coupled to each other.
